(19) United States
(12) Patent Application Publication
(10) Pub. No.: US 2025/0118987 A1
(43) Pub. Date: Apr. 10, 2025

(54) CAPTURING AND STORING STATIC ELECTRICITY

(71) Applicant: Z.A. ARGO LTD., Tiberias (IL)

(72) Inventor: Zvi NACHUM, Tiberias (IL)

(21) Appl. No.: 18/985,078

(22) Filed: Dec. 18, 2024

Related U.S. Application Data
(63) Continuation-in-part of application No. PCT/IB2023/056340, filed on Jun. 20, 2023.

(30) Foreign Application Priority Data
Jun. 23, 2022 (GB) 2209250.6

(51) Int. Cl. H02J 7/34; H05F 7/00

(52) U.S. Cl. CPC H02J 7/345; H05F 7/00; H02J 2207/50

(57) ABSTRACT

A system for collection of static electricity deploys a plurality of planar capacitors connected in parallel and aligned to form a capacitor stack, which has two parallel and opposing major surfaces arranged for receiving a static electricity charge from the atmosphere. The system also includes electronic circuitry in communication with the capacitor stack. The electronic circuitry is configured to cause the static electricity charge to at least partially discharge thereinto so as to prepare the capacitor stack for receiving an additional static electricity charge from the atmosphere.

### CROSS-REFERENCE TO RELATED APPLICATIONS

The present patent application is a CIP of PCT/IB2023/056340 filed on Jun. 20, 2023, which is incorporated herein by reference in its entirety. PCT/IB2023/056340 claims priority to United Kingdom patent application GB2209250.6, filed on Jun. 23, 2022, which is incorporated herein by reference in its entirety.

### FIELD OF THE INVENTION

The present invention relates to capturing static electricity charges from the atmosphere, and in particular to systems and methods for storing static electricity charges in an energy storage device.

### BACKGROUND

Devices and methods are known for capturing static electricity for the purpose of protecting devices such as electronic apparatus from static discharge. Further, devices and methods have been disclosed for capturing static electricity from one or moving parts of a system, e.g., of a rotating automobile tire. Given the abundance of energy available from static electricity charges harvestable from the atmosphere, there is a need for a system that efficiently collects such charges and stores them for future use and/or profit.

### SUMMARY

Embodiments of the present invention relate to systems and methods for collecting static electricity by capturing and storing static electricity charges from the atmosphere.

According to embodiments, a system for collection of static electricity comprises: (a) a plurality of planar capacitors connected in parallel and aligned to form a capacitor stack, the capacitor stack having two parallel and opposing major surfaces arranged for receiving, from the atmosphere, a static electricity charge; and (b) electronic circuitry in communication with said capacitor stack and configured to cause the static electricity charge to at least partially discharge thereinto so as to prepare said capacitor stack for receiving, from the atmosphere, an additional static electricity charge.

In some embodiments, the system can further comprise an energy storage device, e.g., a storage battery, in communication with the electronic circuitry, for storing at least a portion of the static electricity charge.

In some embodiments, the system can further comprise a power supply configured to provide a DC voltage to said capacitor stack.

In some embodiments, said electronic circuitry can include a diode bridge for establishing a polarity of the at least partially discharged static electricity charge.

In some embodiments, said electronic circuitry can include an electrolytic capacitor arranged for at least partial discharge thereinto of the received electricity charge, and said electrolytic capacitor can have a capacitance at least 50% larger than a capacitance of the capacitor stack, or at least 100% larger, or at least 200% larger.

In some embodiments, said electronic circuitry can include a Zener diode upstream of said storage battery.

In some embodiments, said electronic circuitry can include a voltage stabilizer upstream of said storage battery.

In some embodiments, said electrolytic capacitor can be arranged for discharge thereof through said voltage stabilizer and into said storage battery.

In some embodiments, said electronic circuitry can include a controller configured to cause the power supply to provide a pulsed voltage to said capacitor stack in response to receiving a signal from said voltage stabilizer.

In some embodiments, said capacitor stack can be mounted such that at least a respective majority of each of said two major surfaces is exposed. In some embodiments, at least 60%, or at least 70%, or at least 80%, or at least 90% of each of said two major surfaces is exposed.

A method is disclosed, according to embodiments, for charging a storage battery. The method comprises: (a) arranging a capacitor stack such that at least a respective majority of each of two parallel and opposing major surfaces of said capacitor stack is exposed to the atmosphere, said capacitor stack comprising a plurality of planar capacitors connected in parallel and aligned to form said capacitor stack; (b) receiving, from the atmosphere, a static electricity charge in said capacitor stack; (c) causing said static electricity charge to at least partially discharge into electronic circuitry placed in communication with said capacitor stack, the at least partially discharging being effective to prepare the capacitor stack for receiving, from the atmosphere, an additional static electricity charge; and (d) storing at least a portion of said static electricity charge in a storage battery placed in communication with said electronic circuitry.

In some embodiments, the method can additionally comprise: providing a DC voltage to said capacitor stack from a power supply.

In some embodiments, said electronic circuitry can include a diode bridge for establishing a polarity of the at least partially discharged static electricity charge.

In some embodiments, said electronic circuitry can include an electrolytic capacitor arranged for at least partial discharge thereinto of the received electricity charge, and said electrolytic capacitor can have a capacitance at least 50% larger than a capacitance of the capacitor stack, or at least 100% larger, or at least 200% larger.

In some embodiments, said electronic circuitry can include a Zener diode upstream of said storage battery.

In some embodiments, said electronic circuitry can include a voltage stabilizer upstream of said storage battery.

In some embodiments, said electrolytic capacitor can be arranged for discharge thereof through said voltage stabilizer and into said storage battery.

In some embodiments, said electronic circuitry can include a controller configured to cause the power supply to provide a pulsed voltage to said capacitor stack in response to receiving a signal from said voltage stabilizer.

In some embodiments, at least 60%, or at least 70%, or at least 80%, or at least 90% of each of said two major surfaces is exposed.

### BRIEF DESCRIPTION OF THE DRAWINGS

The invention will now be described further, by way of example, with reference to the accompanying drawings, in which the dimensions of components and features shown in the figures are chosen for convenience and clarity of presentation and not necessarily to scale. In the drawings:

FIG. 1 is a schematic perspective view of a residential property showing exemplary locations for installations of a capacitor stack, according to embodiments of the present invention.

FIG. 2 is a schematic perspective view of a capacitor stack and mechanical supports, according to embodiments of the present invention.

FIG. 3 a schematic perspective view showing selected components of a capacitor stack according to embodiments of the present invention.

FIG. 4 shows a stack make-up of an exemplary capacitor stack, according to embodiments of the present invention.

FIG. 5 is a schematic electrical diagram showing selected elements of a system for collection of static electricity, according to embodiments of the present invention.

FIG. 6 is a schematic electrical diagram showing elements for storage and conversion to AC electricity static electricity, according to embodiments of the present invention.

FIG. 7 is a schematic electrical diagram showing elements of an exemplary voltage stabilizer, according to embodiments of the present invention.

FIG. 8 is a block diagram of a controller, according to embodiments of the present invention.

FIGS. 9A, 9B, 9C, and 10 show flowcharts of methods and method steps for charging a storage battery, according to embodiments of the present invention.

### DETAILED DESCRIPTION OF THE ILLUSTRATED EMBODIMENTS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. Throughout the drawings, like-referenced characters are generally used to designate like elements. Throughout this disclosure, subscripted reference numbers (e.g., 10₁ or 10_{A}) may be used to designate multiple separate appearances of elements of a single species, whether in a drawing or not; for example: 10₁ is a single appearance (out of a plurality of appearances) of element 10. The same elements can alternatively be referred to without subscript (e.g., 10 and not 10₁) when not referring to a specific one of the multiple separate appearances, i.e., to the species in general.

Some embodiments of the invention relate to systems for collection of static electricity. The static electricity is directly collected on the two exposed major surfaces of a capacitor stack, for example a stack of planar capacitors. The capacitor stack can have a prismatic shape to increase the available collection surface. Without adhering to a specific theory, electrically charged particles in the atmosphere come into contact with the collection surface of the two major surfaces, whereupon electrical charge is transferred to the collection surface. It can be desirable for the capacitor stack to be deployed, e.g., mounted, with the two major surfaces exposed to the environment to the extent possible, e.g., at least 50% of the surface area, or at least 60%, or at least 70%, or at least 80%, or at least 90% of the charge collection area each of the two major surfaces is exposed. It can therefore be desirable to design the mounting arrangements so as not to cover more than a de minimis portion of the collection surface, and in some designs, 100% of the collection surface can be exposed. The stack of capacitors is preferably connected in parallel for increased capacitance. Less optimized designs, e.g., including inadequately exposed collection surface, series wiring of the capacitors, and/or use of non-planar capacitors, nonetheless remain within the scope of the present invention.

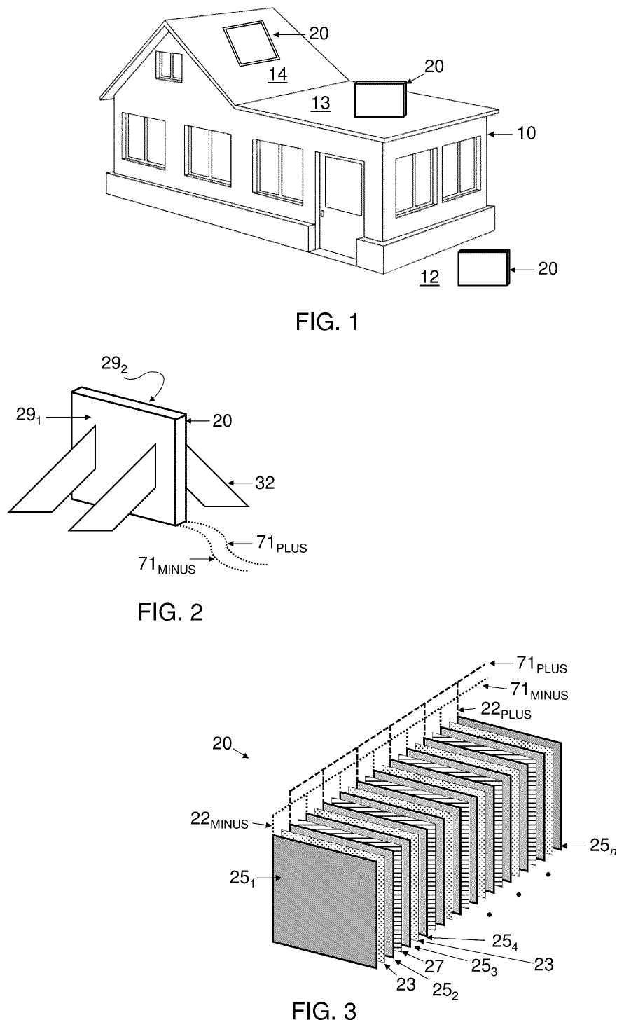

We now refer to the figures, and in particular to FIGS. 1 and 2. Examples are shown of deployment, e.g., mounting, of capacitor stacks 20. FIG. 1 shows a building 10, e.g., a residential building, where capacitor stacks 20 are shown deployed on the ground 12, on a flat roof 13, and on a slanted roof 14. In an alternative embodiment (not shown), a capacitor stack 20 is laid on the slanted roof 14 at the same angle of the roof. Notably, this orientation prevents the entire surface area of one of two major surface areas 29 from being exposed to the atmosphere, and therefore collects less static electricity from the atmosphere. FIG. 2 shows a non-limiting example of mounting arrangements 37 for deploying the capacitor stack 20 on a flat surface 12, 13 while leaving at least 90% of the surface area of each of the two major surfaces 29₁, 29₂ exposed.

Another example of deploying capacitor stacks 20 for collection of static electricity from the atmosphere involves implementation of the embodiments in static electricity ‘farms’ or ‘power plants’ (not shown), i.e., analogous to so-called solar ‘farms’ and powerplants at electric utility scale. In such an example, an array of capacitor stacks can include any number of capacitor stacks.

FIG. 3 shows the internal structure of an exemplary capacity stack 20. A total of n conduction plates 25, i.e., plates 25₁ to 25ₙ, are assembled with a separator layer chosen from separator layers 23, 27 interposed between each pair of consecutive conduction plates 25. The separator layers 23, 27 can be selected on the basis of electrical insulation properties and/or dielectric properties. In some embodiments, the two types of separator layers 23, 27 all use the same material. In other embodiments, the separator layers 23, 27 all use the same materials but are differentiated by thickness. In the non-limiting example of FIG. 3, a first capacitor includes the first conduction plate 25₁, separator layer 23, and the second conduction plate 25₂. Another separator layer 27 is deployed between capacitors. A second capacitor includes the third conduction plate 25₃, another separator layer 23, and the fourth conduction plate 25₄. This pattern continues until the final (n/2)th capacitor, which includes conduction plates 25ₙ₋₁, 25ₙ with a separator layer 23 sandwiched therebetween.

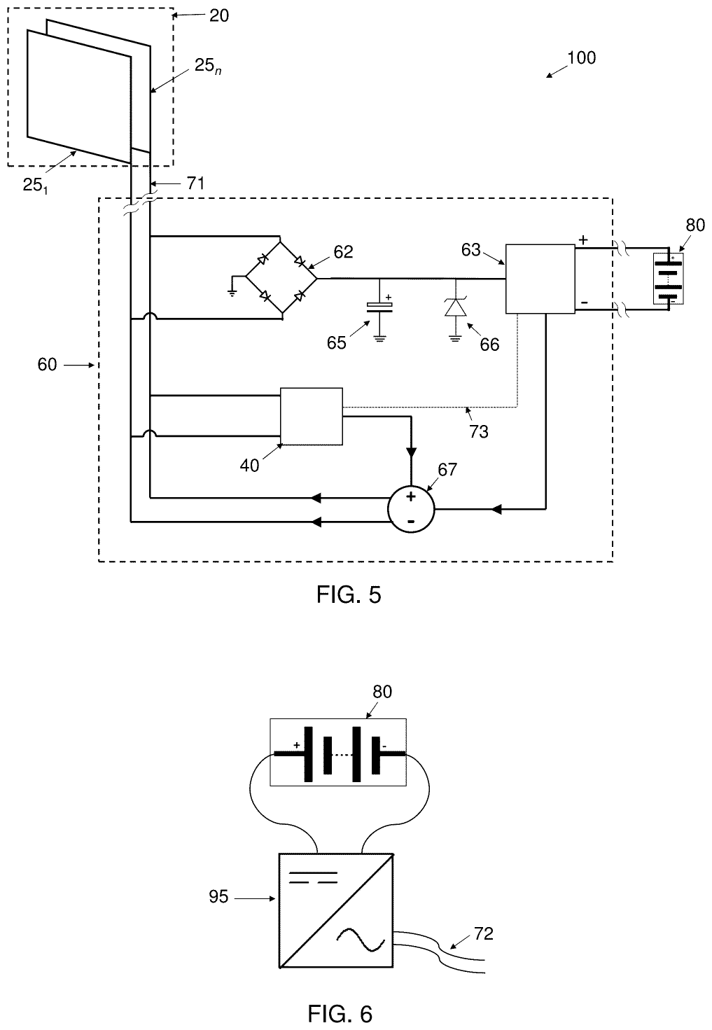

Each conduction plate 25 is in contact with an electrical terminal 22, and specifically, in light of the capacitors being electrically arranged in parallel, with alternating ‘plus’ terminals 29_{PLUS} and ‘minus’ terminals 29_{MINUS}. Electrical leads 71_{PLUS} and 71_{MINUS} are current collectors for the stack and lead to other elements of the system 100 as shown in FIG. 5. It should be clear that the designations ‘plus’ and ‘minus’ with respect to both the terminals 29 and the electrical leads 71 are merely illustrative, and the plus and minus can be reversed.

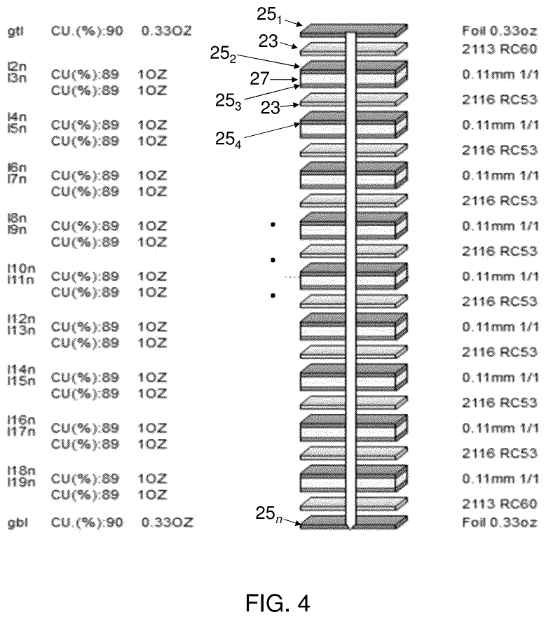

A similar stack structure is shown in the stack layout presented in FIG. 4, where differences in the design of the first and last capacitors in the stack from the intermediate capacitors are disclosed. In the non-limiting example of FIG. 4, the first and last separator layers 23 are made of a slightly different dielectric material (2113 RC60) than are the rest of the separator layers 23 (2116 RC53). The first and last conduction plates 25₁, 25ₙ are formed of a higher copper-content allow than the intervening conduction plates (90% vs. 89%) and are thinner, comprising only a third of the weight, thereby reducing electrical resistance for improved transfer of static charges to the exposed surfaces. The end plates 25₁, 25ₙ are described in FIG. 4 as foils because they are substantially thinner than the plates and may be applied using a coating process or a foil-application process.

In embodiments, it can be desirable to select materials with appropriate triboelectric properties for enhancing the generation of static electricity on surfaces when exposed to regular air, humid air, water aerosols, or rain. The triboelectric effect can leverage the tendency of different materials to become electrically charged upon contact and separation. To increase or maximize electric charge generation, it can be desirable to use materials located at opposite ends of the triboelectric series. In other words, using two materials with opposite triboelectric tendencies, e.g., with a first material tending to a positive charge and the second material to a negative charge, amplifies the overall effect.

In embodiments, coating materials can be selected for resistance to corrosion, UV radiation, extreme temperatures, and/or mechanical wear. Coating materials can be applied through any suitable coating processing, including, without limitation, spraying, dip coating and plasma coating.

Examples of suitable materials for surface coating of exposed surfaces include, without limitation:
PTFE (polytetrafluoroethylene) is a fluoropolymer with high electronegativity, tending to accept electrons and become negatively charged. PTFE exhibits high chemical and physical resistance, hydrophobic properties and low coefficient of friction. Coating surfaces with PTFE enhances electric charge generation when water or humid air passes over them.
PDMS (polydimethylsiloxane) is a flexible, transparent silicone polymer with hydrophobic characteristics. PDMS exhibits mechanical flexibility, thermal stability, and ease of processing.
Aluminum is a lightweight metal that tends to lose electrons and become positively charged. Aluminum is known for high electrical conductivity and ease of processing, and is relatively resistant to corrosion.
Nylon (polyamide) is a synthetic polymer that tends to become positively charged. Nylon exhibits high mechanical strength, abrasion resistance, and ease of processing. In some embodiments, nylon can be combined with materials like PTFE to create a significant charge differential.

Hydrophobic materials such as PTFE and PDMS allow water to glide easily over the surface, enhancing triboelectric interactions with water droplets or aerosols.

In embodiments, it can be desirable to enhance surface topography of exposed surfaces, e.g., by creating a surface with nanostructured topography (e.g., nano-grooves or nano-pillars) to increase the surface area and improve electric charge generation.

According to embodiments, a system 100 for collection of static electricity includes electronic circuitry in communication with the capacitor stack. The term “electronic circuitry” as used herein and in the appended claims is used broadly to include any electrical and/or electronic circuitry, as well as any electrical and/or electronic components, including hardware, firmware, and/or software, and potentially including both off-the shelf components and custom-designed components.

The electronic circuitry of the present embodiments is configured, inter alia, to cause the static electricity charge received by the capacitor stack from the atmosphere to at least partially discharge into the electronic circuitry, or into one or more of its components. In embodiments, the discharge is a discharge of nearly all of the charge collected by the capacitor stack, e.g., at least 90%, or at least 80%, or at least 70%, or at least 60% of the collected charge. This prepares the capacitor stack for receiving an additional static electricity charge from the atmosphere, and also facilitates the storage of at least part of the collected static charge in a storage battery. The term “storage battery” means any rechargeable energy storage device and is not limited to electrochemical storage.

Reference is now made to FIGS. 5, 6, 7 and 8. A system 100 for collection of static electricity comprises a capacitor stack 20, electronic circuitry 60, and an energy storage device, e.g., a storage battery 80. The electronic circuitry 60 is configured to ‘pump’ static charges from the capacitor stack 20 and through the electronic circuitry 60 to the energy storage device 80. This is accomplished in part by maintaining lower voltage downstream relative to the voltages of the static charge in the capacitor stack 20. A DC power supply 67 is provided to supply a voltage, e.g., a steady voltage or a pulsed voltage, or both at different times. The voltage supplied by the DC power supply 67 is specific to an implementation; examples of suitable voltages are voltages in the ranges 3-6 V, 6-12 V, 12-24 V, and 24-48V. The charges ‘collected’ by the capacitor stack 20 generally carry a higher voltage, for example over 50 V, or over 100 V, or over 1000 V, or over 5000V. Flow of the charges can out of the capacitor stack can be at a very low current, e.g., less than 1 mA (milliampere) or less than 100 μA (microampere) or less than 10 μA.

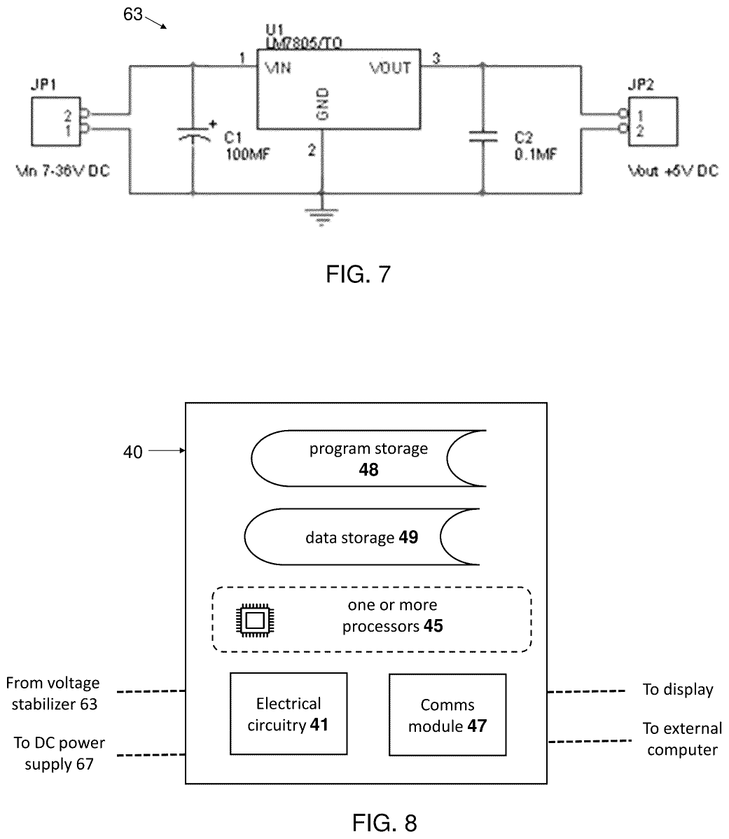

The charge collected by the capacitor stack 20 is of unknown polarity, and therefore, as illustrated in FIG. 5, current first flows through a bridge diode 62 to establish a polarity of the current, e.g., a positive polarity. From there, the current flows to a capacitor 65, e.g., an electrolytic capacitor having a capacitance at least 50% larger than a capacitance of the capacitor stack 20, or at least 100% larger, or at least 200% larger, or at least 500% larger, or at least 1000% larger. The electrolytic capacitor 65 is configured to store the electrical charge temporarily, i.e., until the difference in voltages signals that the charge is to be emptied into the circuit in the direction of the battery. A Zener diode 66 is set to be effective at a voltage close to the voltage of the battery 80, e.g., up to 10% higher, or up to 20% higher, or up to 50% higher, or higher, and thereby protect both the battery 80 and the voltage stabilizer 63 downstream from the Zener diode 66 and upstream of the battery 80. The voltage stabilizer 63 is configured to deliver a substantially constant voltage for charging the storage battery 80. An illustrative example of a simple voltage stabilizer 63 is shown in FIG. 7. As shown, the illustrative example accommodates an input voltage of 7-36 V and outputs a steady 5 V. Thus, the portion of the electronic circuitry 60 from the bridge diode 62 to the voltage stabilizer 63 is, in combination, configured to convert high-voltage, low-current electrical charges of unknown polarity collected by the capacitor stack 20 from the atmosphere to electricity of a known polarity and at a charging voltage suitable for the storage battery 80. As shown schematically in FIG. 6, the DC electricity stored in the energy storage device 80 is converted to AC electricity by the inverter 95, from where it can flow into a local or wide electricity grid through electrical leads 72.

A controller 40 is provided, inter alia, for causing the DC power supply 67 to put out voltage pulses for inducing the discharge of the capacitor stack in the direction of the lower downstream voltage. Optional communications path 73 can be provided for the controller 40 to receive a signal from the voltage stabilizer 63 for triggering the voltage pulses based on a state of the voltage stabilizer 63. In some embodiments, the controller 40 is also configured to pause the steady or pulsed voltage provided by the DC power supply 67 in order to assess one or more system parameters. Following the assessment, the controller 40 is configured to resume providing the steady or pulsed voltage. The one or more assessed system parameters can include, for example and not exhaustively, a charge status, a current and/or a voltage. The one or more system parameters can be assessed at any one or more of a number of locations in the system 100, such as, for example and not exhaustively, at or downstream of the capacitor stack 20; at, upstream of or downstream of the bridge diode 62; at, upstream of or downstream of the capacitor 65; or at or upstream of the Zener diode 66. In embodiments, the pause is between 1 and 20 seconds, or between 1 and 10 seconds, or between 2 and 3 seconds. In embodiments, the controller 40 is further configured to take an action in response to the assessment. In an example, the system parameter assessed is the state of charge of the capacitor stack 20 and the action taken is to increase or decrease an amplitude or a frequency of a voltage pulses from the DC power supply 67. In an example, the assessment reveals at least one of: a charge greater than a predetermined charge in the capacitor stack 20, a voltage higher than a predetermined voltage at or upstream of the Zener diode 66, and a current higher than a predetermined current measured at any point between the bridge diode 62 and the storage battery 80. According to the example, the action taken responsively to the assessment including cessation of the steady or pulsed voltage from the DC power supply 67 for a set period of time, e.g., at least one minute and not more than 120 minutes, or at least one minute and not more than 60 minutes, or at least one minute and not more than 30 minutes, and/or until a subsequent assessment. This exemplary response to the assessment can be implemented, inter alia, to save energy when substantial static electricity is being captured and stored and the providing of steady or pulsed voltage by the DC power supply 67 might be is unnecessary.

FIG. 8 shows a block diagram of an exemplary controller 40. The term “controller” is used to mean any hardware, software and/or firmware deployed in connection with, inter alia, data communication, programming, data processing, data storage, measurements, and/or calculations for regulating one or more functions of the system 100 and components thereof disclosed herein for collection of static electricity.

In the instant example of the controller illustrated in FIG. 8, the controller 40 can include, and not exhaustively, any or all of the following components: one or more computer processors 45; non-transient program storage 48 for storing therein program instructions for execution by the one or more computer processors 45; transient and/or non-transient data storage 45 for storing therein, and not exhaustively: measurements, calculations, and/or historical data; electrical circuitry 41 in communication with the electrical wiring of the electronic circuitry 60, and a communications module 47, e.g., for communicating information about operation of the system 100 to a display and/or to an external computer. A power source for the electronics can be provided but is not shown in FIG. 8. In some embodiments, the electronic circuitry 40 includes, and stores for execution by the one or more processors 45, program instructions for performing control functions, such as causing the DC power supply 67 to provide a pulsed voltage to the capacitor stack 20 in response to receiving a signal from the voltage stabilizer 63.

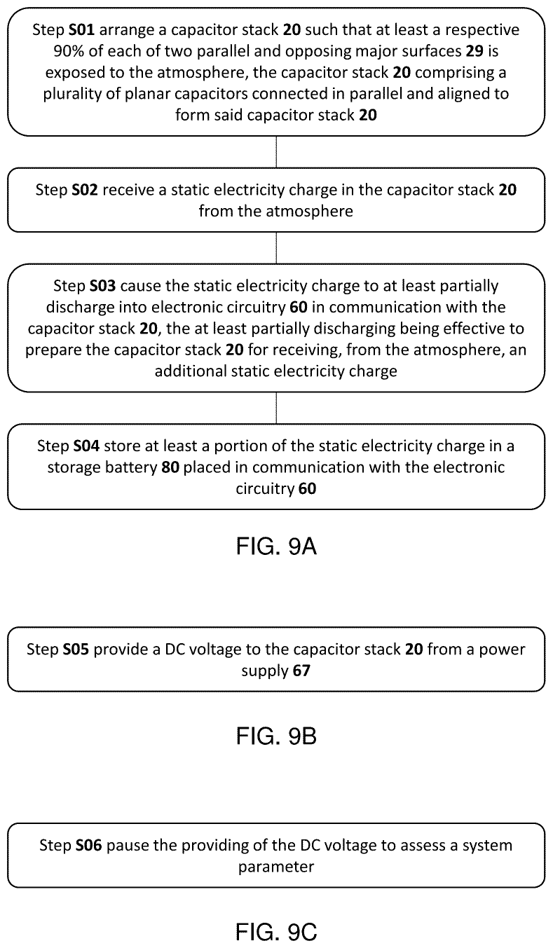

Referring now to FIG. 9A, a method is disclosed for charging a storage battery, e.g., storage battery 80 of a system 100 according to any the embodiments disclosed herein. As illustrated by the flowchart in FIG. 9A, the method comprises at least the four method steps S01, S02, S03, and S04:

Step S01: arranging a capacitor stack 20 such that at least a respective 90% of each of two parallel and opposing major surfaces 29 is exposed to the atmosphere, the capacitor stack 20 comprising a plurality of planar capacitors connected in parallel and aligned to form said capacitor stack 20.

Step S02: receiving a static electricity charge in the capacitor stack 20 from the atmosphere.

Step S03: causing the static electricity charge to at least partially discharge into electronic circuitry 60 in communication with the capacitor stack 20, the at least partially discharging being effective to prepare the capacitor stack 20 for receiving, from the atmosphere, an additional static electricity charge.

Step S04: storing at least a portion of the static electricity charge in a storage battery 80 placed in communication with the electronic circuitry 60.

In some embodiments, the method additionally comprises method step S05, illustrated by the flow chart in FIG. 9B:

Step S05: providing a DC voltage to the capacitor stack 20 from a power supply 67.

In some embodiments, the method additionally comprises method step S06, illustrated by the flow chart in FIG. 9C:

Step S06: pausing the providing of the DC voltage by the power supply 67 (as disclosed in Step S05) to assess a system parameter.

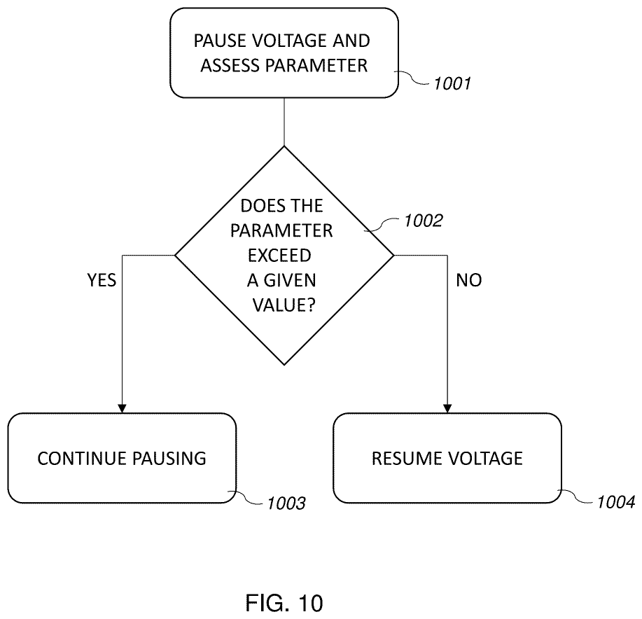

FIG. 10 shows a flowchart illustrating an exemplary implementation of Step S06. According to the example, of FIG. 10, Step S06 begins with pausing the providing of the DC voltage and assessing a system parameter, as shown in Box 1001. The parameter value, e.g., electrical charge, voltage, and/or current, as detailed hereinabove, is checked (See Box 1002) to see whether it exceeds a predetermined value. If it is determined that the predetermined value is exceeded (See Box 1003), then the providing of steady or pulsed voltage is further suspended for a period of time. The suspension can be ended automatically on the basis of time, or in response to another assessment of the system parameter. If it is determined that the predetermined value is not exceeded (See Box 1004), the providing of steady or pulsed voltage is resumed.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons skilled in the art to which the invention pertains.

1. A system for collection of static electricity, comprising:
a. a plurality of planar capacitors connected in parallel and aligned to form a capacitor stack, the capacitor stack having two parallel and opposing major surfaces arranged for receiving, from the atmosphere, a static electricity charge;
b. electronic circuitry in communication with said capacitor stack and configured to cause the static electricity charge to at least partially discharge thereinto so as to prepare said capacitor stack for receiving, from the atmosphere, an additional static electricity charge; and
c. a power supply configured to provide a DC voltage to said capacitor stack.

2. The system of claim 1, further comprising a storage battery in communication with the electronic circuitry, for storing at least a portion of the static electricity charge.

3. The system of claim 1, wherein said electronic circuitry includes a diode bridge for establishing a polarity of the at least partially discharged static electricity charge.

4. The system of claim 1, wherein said electronic circuitry includes an electrolytic capacitor arranged for at least partial discharge thereinto of the received electricity charge, said electrolytic capacitor having a capacitance at least 50% larger than a capacitance of the capacitor stack.

5. The system of claim 2, wherein said electronic circuitry includes a Zener diode upstream of said storage battery.

6. The system of claim 2, wherein said electronic circuitry includes a voltage stabilizer upstream of said storage battery.

7. The system of claim 6, wherein said electrolytic capacitor is arranged for discharge thereof through said voltage stabilizer and into said storage battery.

8. The system of claim 6, wherein said electronic circuitry includes a controller configured to cause the power supply to provide a pulsed voltage to said capacitor stack in response to receiving a signal from said voltage stabilizer.

9. The system of claim 1, wherein said capacitor stack is mounted such that at least a respective majority of each of said two major surfaces is exposed.

10. The system of claim 9, wherein at least 60% of each of said two major surfaces is exposed.

11. The system of claim 1, mounted on a building.

12. The system of claim 1, mounted on a vehicle.

13. A method for charging a storage battery, the method comprising:
a. arranging a capacitor stack such that at least a respective majority of each of two parallel and opposing major surfaces of said capacitor stack is exposed to the atmosphere, said capacitor stack comprising a plurality of planar capacitors connected in parallel and aligned to form said capacitor stack;
b. providing a DC voltage to said capacitor stack from a power supply;
c. receiving, from the atmosphere, a static electricity charge in said capacitor stack; and
d. causing said static electricity charge to at least partially discharge into electronic circuitry placed in communication with said capacitor stack, the at least partially discharging being effective to prepare the capacitor stack for receiving, from the atmosphere, an additional static electricity charge.

14. The method of claim 13, additionally comprising: storing at least a portion of said static electricity charge in a storage battery placed in communication with said electronic circuitry.

15. The method of claim 13, wherein said electronic circuitry includes a diode bridge for establishing a polarity of the at least partially discharged static electricity charge.

16. The method of claim 13, wherein said electronic circuitry includes an electrolytic capacitor arranged for at least partial discharge thereinto of the received electricity charge, said electrolytic capacitor having a capacitance at least 50% larger than a capacitance of the capacitor stack.

17. The method of claim 13, wherein said electronic circuitry includes a Zener diode upstream of said storage battery.

18. The method of claim 13, wherein said electronic circuitry includes a voltage stabilizer upstream of said storage battery.

19. The method of claim 13, wherein said electrolytic capacitor is arranged for discharge thereof through said voltage stabilizer and into said storage battery.

20. The method of claim 13, wherein said electronic circuitry includes a controller configured to cause the power supply to provide a pulsed voltage to said capacitor stack in response to receiving a signal from said voltage stabilizer, and wherein said providing of said DC voltage includes providing said pulsed voltage.
